(19) United States
(12) Patent Application Publication
(10) Pub. No.: US 2025/0117955 A1
(43) Pub. Date: Apr. 10, 2025

(54) OBSTACLE AVOIDANCE USING A MONOCULAR CAMERA IN A VEHICLE

(71) Applicants: YOKOGAWA SAUDI ARABIA COMPANY L.L.C., Al-Khobar (SA); KING FAHD UNIVERSITY OF PETROLEUM AND MINERALS, Dhahran (SA)

(72) Inventors: Abdulrahman Basharat JAVAID, Dammam (SA); Uthman Abdurrahman BAROUDI, Dhahran (SA); Asaad Abdulsalam ALDUAIS, Munich (DE); Mohammad Hashem Mohammad Kenana SHULLAR, Riyadh (SA)

(21) Appl. No.: 18/483,190

(22) Filed: Oct. 9, 2023

(51) Int. Cl. G06T 7/55; G06V 20/17; G08G 5/00; G08G 5/04

(52) U.S. Cl. CPC G06T 7/55; G06V 20/17; G08G 5/34; G08G 5/80; G06T 2207/10024; G06T 2207/20084

(57) ABSTRACT

Obstacle avoidance by a remote or autonomously operated vehicle, such as an unmanned aerial vehicle (UAV), is of critical importance. By utilizing a monocular camera, a UAV may capture an image and select a middle sub-image for processing. If the average depth of the pixels in the middle sub-image is greater than a previously determined threshold, the UAV may proceed forward. However, if the average depth of the pixels is less than the threshold, a turn is required. A left sub-image and a right sub-image are processed and, based on the one having the greatest depth, a turn instruction is provided to the UAV.

### FIELD OF THE DISCLOSURE

The invention relates generally to systems and methods for obstacle avoidance and particularly to obstacle avoidance utilizing a monocular camera.

### BACKGROUND

Obstacle avoidance is a critical task for unmanned aerial vehicles (UAVs) and semi-autonomous vehicles to operate safely in complex environments. Traditional obstacle avoidance systems rely on multiple sensors, such as LiDAR, and depth cameras, which can be expensive, power-consuming, and bulky. Monocular cameras are a more affordable, lightweight, and compact alternative for obstacle avoidance. However, monocular cameras only provide two-dimensional (2D) information, making it challenging to accurately estimate the distance to obstacles and make precise obstacle avoidance decisions. Recent advances in deep learning have made it possible to estimate depth from monocular images with low accuracy.

### SUMMARY

UAVs and semi-autonomous vehicles require obstacle avoidance to operate safely and effectively. Like all on-board UAV components, obstacle avoidance components benefit from minimized size, weight, power consumption, and cost, which are at a premium.

These and other needs are addressed by the various embodiments and configurations of the present invention. Embodiments of the present invention can provide a number of advantages depending on the particular configuration. These and other advantages will be apparent from the disclosure of the invention(s) contained herein.

Embodiments herein are directed to obstacle avoidance systems and methods that utilize images obtained from a camera, such as a monocular camera. It should be appreciated that embodiments may be applied to other types of cameras and imaging devices. The images are then processed with deep learning, such as a trained neural network, having a low-accuracy depth estimation model to generate highly precise obstacle avoidance decisions. Embodiments herein are directed to a vehicle, such as a UAV, that operates autonomously to detect and avoid obstacles rather than utilizing control inputs from a human operator. The avoidance of obstacles may be performed during autonomous operation of the UAV or as a safety feature to override a control input from a remote operator, such as a human or computer (e.g., swarm controller), that would otherwise result in a collision with an obstacle.

In one embodiment, precise obstacle avoidance decisions are made with low accuracy in depth estimation. A depth map and corresponding depth matrix of a monocular image are generated. The depth matrix is then segmented into three segments: right, middle, and left. If the UAV camera is located in the middle of the UAV hardware, the middle segment is utilized, which corresponds to the majority of UAVs. If the monocular camera is located on the left portion of the UAV, the right segment is utilized and, similarly, the left segment is utilized with the monocular camera located on the right portion of the UAV. After generation of the depth map and depth matrix, the average of all depth values present in that segment is calculated. If the average is lower than a pre-defined threshold, obstacle avoidance is required and an avoidance decision to avoid the obstacle is made.

To determine the pre-defined threshold, a range of pixel depths for which the deep learning model provides consistent depth estimations is identified. For example, a deep learning model determines the distance or depth to obstacles placed 1.5 to 2 meters away is consistent, although not necessarily accurate. As a result, the threshold is determined and set to the smallest consistent value, in this example, 1.5 meters.

In some aspects, the techniques described herein relate to an obstacle avoidance method for an unmanned vehicle, including: receiving an image taken from a camera that is mounted on a position of the unmanned vehicle operated to fly within a flight path, wherein the camera has a field of view and a predetermined image size; selecting a sub-image from the image for obstacle avoidance computation based on at least one of the field of view of the camera and the predetermined image size; computing an average image depth value for all pixels in the selected sub-image; comparing the average image depth value with a threshold value; determining a presence of an obstacle based on the comparing; and initiating an avoidance maneuver when the presence of the obstacle is determined based on the comparing so as to enable the unmanned vehicle to avoid the obstacle.

In some aspects, the techniques described herein relate to a method, wherein the average image depth value for all pixels is computed using a trained model, wherein the trained model includes a probabilistic convolutional neural network.

In some aspects, the techniques described herein relate to a method, wherein the selecting the sub-image from the image taken from the camera includes dividing the image into a plurality of sub-images that includes the selected sub-image, and wherein at least two of the plurality of sub-images are non-overlapping.

In some aspects, the techniques described herein relate to a method, further including: computing a depth map for each of a plurality of sub-images by computing an average depth for each of the plurality of sub-images.

In some aspects, the techniques described herein relate to a method, wherein each of the plurality of sub-images includes a similar size.

In some aspects, the techniques described herein relate to a method, wherein the computing, determining, and initiating are performed on the selected sub-image and the plurality of sub-images other than the selected sub-image is not used for the computing so as to reduce computing time.

In some aspects, the techniques described herein relate to a method, wherein the selected sub-image includes a size that is determined based on a size of the unmanned vehicle and a resolution and field of view (FOV) of the camera.

In some aspects, the techniques described herein relate to a method, wherein the unmanned vehicle is moved in a direction away from the selected sub-image.

In some aspects, the techniques described herein relate to a method, further including: capturing a first sub-image at a first time and a second sub-image at a second time for the selected sub-image, wherein the second time occurs after the first time.

In some aspects, the techniques described herein relate to a method, further including: computing a rotation parameter using the first sub-image and the second sub-image; applying a first weight to the first sub-image; and applying a second weight to the second sub-image, wherein the second weight is higher than the first weight.

In some aspects, the techniques described herein relate to a method, further including: performing a rotation operation on the unmanned vehicle using the rotation parameter upon determining the presence of the obstacle.

In some aspects, the techniques described herein relate to a vehicle control system, including: a processor configured to receive an image taken from a camera, wherein the camera has a field of view and a predetermined image size; and memory including data stored thereon that, when executed by the processor, enables the processor to: select a sub-image from the image for an obstacle avoidance computation based on at least one of the field of view of the camera and the predetermined image size; compute an average image depth value for all pixels in the selected sub-image; compare the average image depth value with a threshold value; determine a presence of an obstacle based on the comparing; and initiate an avoidance maneuver for the vehicle when the presence of the obstacle is determined based on the comparing so as to enable the vehicle to avoid the obstacle.

In some aspects, the techniques described herein relate to a vehicle control system, wherein the average image depth value for all pixels is computed using a trained model, wherein the trained model includes a probabilistic convolutional neural network.

In some aspects, the techniques described herein relate to a vehicle control system, wherein the image is divided into a plurality of sub-images, wherein the sub-image is selected from the plurality of sub-images.

In some aspects, the techniques described herein relate to a vehicle control system, wherein the image includes at least one of a red-green-blue (RGB) image.

In some aspects, the techniques described herein relate to a vehicle control system, wherein the vehicle includes an unmanned vehicle.

In some aspects, the techniques described herein relate to a vehicle control system, wherein the avoidance maneuver includes adjusting a flight path of the vehicle.

In some aspects, the techniques described herein relate to a system, including: a camera; a processor; and memory coupled with the processor, wherein the memory includes data stored thereon that, when executed by the processor, enables the processor to: select a sub-image from an image for an obstacle avoidance computation based on at least one of a field of view of the camera and a predetermined image size; compute an average image depth value for all pixels in the selected sub-image; compare the average image depth value with a threshold value; determine a presence of an obstacle based on the comparing; and initiate an avoidance maneuver for a vehicle when the presence of the obstacle is determined based on the comparing so as to enable the vehicle to avoid the obstacle.

In some aspects, the techniques described herein relate to a system, wherein the data further enables the processor to: capture a first sub-image; capture a second sub-image; apply a first weight to the first sub-image; apply a second weight to the second sub-image, wherein the second weight is different from the first weight; and compute a rotation parameter based on applying the first weight to the first sub-image and based on applying the second weight to the second sub-image.

In some aspects, the techniques described herein relate to a system, wherein the data further enables the processor to: instruct a vehicle to perform a rotation operation using the rotation parameter.

In some aspects, the techniques described herein relate to a system, further comprising: a communication interface to a network; and a vehicle comprising the camera, first processor, first memory, and the communication interface; and wherein the first processor computes the average image depth value for all pixels in the selected sub-image comprising providing the selected sub-image, via the network, to a second processor located externally to the vehicle and receiving therefrom the average image depth value for one or more of all pixels.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a UAV operation in accordance with embodiments of the present disclosure;

FIG. 2 depicts a process in accordance with embodiments of the present disclosure;

FIG. 3 depicts image processing in accordance with embodiments of the present disclosure;

FIG. 4 depicts an algorithm in accordance with embodiments of the present disclosure;

FIG. 5 depicts a camera image in accordance with embodiments of the present disclosure;

FIG. 6 depicts a depth map in accordance with embodiments of the present disclosure;

FIG. 7 depicts a data structure in accordance with embodiments of the present disclosure;

FIG. 8 depicts a camera image divided into sub-windows in accordance with embodiments of the present disclosure;

FIG. 9 depicts a camera image in accordance with embodiments of the present disclosure;

FIG. 10 depicts a depth map in accordance with embodiments of the present disclosure; and

FIG. 11 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

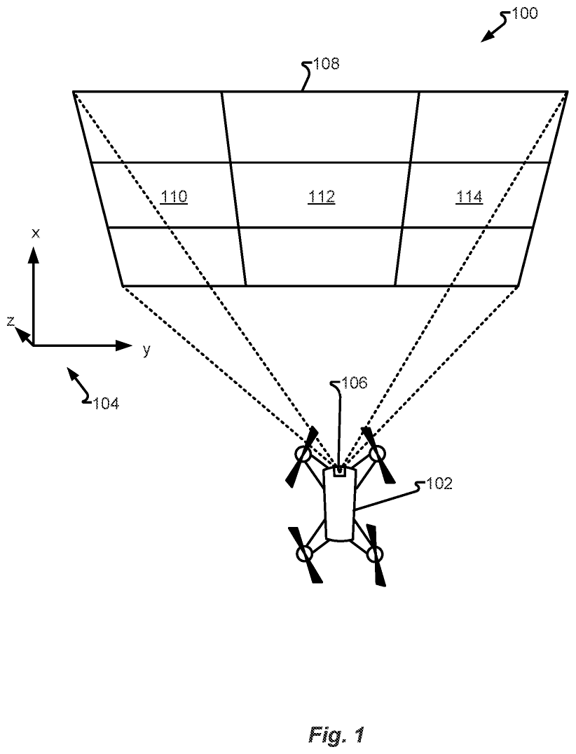

FIG. 1 depicts UAV 102 operation 100 in accordance with embodiments of the present disclosure. It should be appreciated that embodiments herein are described with respect to UAV 102 comprising an aerial vehicle. However, it should be appreciated that UAV 102 may be embodied as an unmanned vehicle configured to navigate on a surface (e.g., water, land, a building, a wall, etc.), in a medium (e.g., water, air, etc.), or a combination thereof, without departing from the scope of the embodiments herein.

UAV 102 operates in three-dimensional (3D) space as indicated by axis 104. Camera 106 is mounted to UAV 102 to take images in a fixed relation to UAV 102. Camera 106 is fixed to UAV 102 and, relative to UAV 102, does not pan, rotate, or zoom. Camera 106 captures images in field of view (FOV) 108, FOV 108 being fixed and having a fixed image size (i.e., a number of pixels). FOV 108 is divided into a plurality of non-overlapping sub-windows, such as left sub-window 110, middle sub-window 112, and right sub-window 114. In one embodiment, camera 106 is a monocular camera. Additionally or alternatively, camera 106 may comprise a monocular camera portion (e.g., a single aperture) of a stereoscopic or other multiple aperture/camera vehicle. The size of any one or more of left sub-window 110, middle sub-window 112, and right sub-window 114 may be determined as a function of the relative size of UAV 102 and the resolution of camera 106. For example, UAV 102, when small, can avoid obstacles with greater precision and, therefore, the size of left sub-window 110, middle sub-window 112, and right sub-window 114 may be smaller. In contrast, UAV 102, when large, may require a greater margin of error to safely avoid obstacles. Similarly, camera 106 may have a low resolution and, as a result, may less accurately detect obstacles. As a result, the size of left sub-window 110, middle sub-window 112, and right sub-window 114 may be larger. Additionally or alternatively, portions of the image, such as any one or more of left sub-window 110, middle sub-window 112, and right sub-window 114, may be captured at different times. For example, if no obstacle is present in middle sub-window 112, capturing images for left sub-window 110 and/or right sub-window 114 may be omitted and performed at a later time, such as when an obstacle is present. As another option, if a turn is required due to an object, and left sub-window 110 indicates an unlimited or sufficiently great depth to any obstacle, then a turn to the left may be initiated without capturing and/or processing information of right sub-window 114.

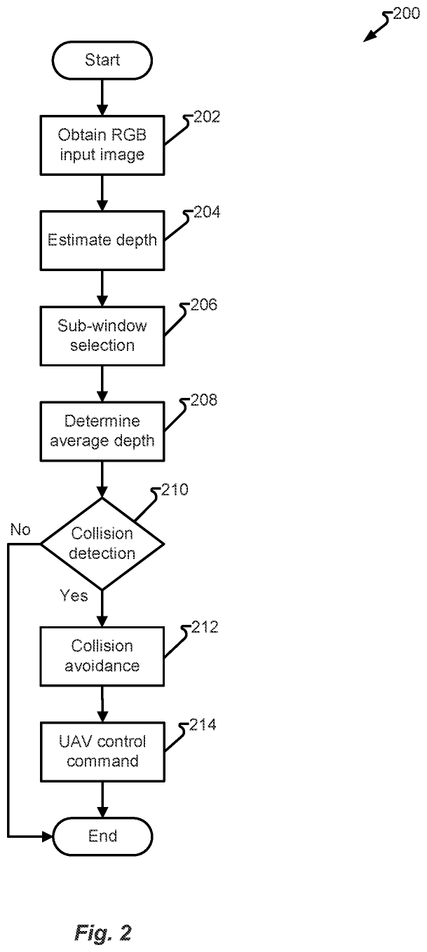

FIG. 2 depicts process 200 in accordance with embodiments of the present disclosure. In one embodiment, process 200 is embodied as machine-readable instructions maintained in a non-transitory memory that when read by a machine, such as processors of UAV 102 and/or another device, cause the machine to execute the instructions and thereby execute process 200.

Process 200 begins (or continues) and, in step 202, captures an image. The image may be a red-green-blue (RGB) image. Step 204 may utilize one or more prior art methodologies for depth estimation for monocular imaging systems, such as Unsupervised Monocular Depth Estimation, Self-Supervised Monocular Depth Prediction, Fast Monocular Depth Estimation, Monocular Depth Estimation via Transfer Learning, and Depth Estimation Using Adaptive Bins. For example, Monocular Depth Estimation via Transfer Learning may be selected, which receives the RGB image (step 202), such as in a 640×480-pixel format, as an input and returns outputs of a depth map along with a matrix that contains depth estimation for each pixel of the input image.

Step 206 then performs sub-window selection. Processing all information in FOV 108 (see FIG. 1) is unnecessarily burdensome as, depending on the direction of travel, FOV 108 contains images that, even if an obstacle is present therein, pose no collision threat. Accordingly, subsequent processing of the image (captured step 202) to detect obstacles may be limited to portions of FOV 108 relevant to the position and the actual or desired direction of travel of UAV 102. Sub-window selection may be determined empirically, such as based on the dimensions of UAV 102 (e.g., larger UAVs may need to utilize a larger sub-window) and/or the location of camera 106 on UAV 102. For example, UAV 102 is illustrated (see FIG. 1) as having camera 106 located in a central location (along the x-axis) of UAV 102. Accordingly, middle sub-window 112 is selected.

For obstacle avoidance, an approximate distance is sufficient to avoid obstacles. The particular operation of a particular UAV 102 (e.g., speed, ability to change/stop travel on one or more axes, etc.) may make certain obstacles irrelevant for collision detection while other obstacles, such as those that may require all or nearly all of the maneuvering ability of UAV 102 to avoid a collision. As a result, a slowly moving and/or highly maneuverable UAV 102 may be unconcerned with obstacles except when a collision is almost imminent. Conversely, a fast moving and/or minimally maneuverable UAV 102 may need to consider obstacles much farther away. Once an obstacle is determined to be within a threshold distance, a specific distance may be irrelevant and, therefore, not determined. For example, determining whether an obstacle is, or is not, closer than two meters from UAV 102 may be sufficient to make an avoidance decision. Accordingly, step 208 determines that an average depth estimation for one or more of left sub-window 110, middle sub-window 112, and/or right sub-window 114 is adequate to achieve the objective of obstacle avoidance. In one embodiment, UAV 102 may be in communication (e.g., utilizing WiFi, Bluetooth, cellular, satellite link, etc.) with a computing device(s) (not shown) such as computing device(s) executing a trained model, wherein the trained model may comprise a probabilistic Convolutional Neural Network (CNN). The CNN utilizes a depth map to determine obstacle avoidance. The CNN may utilize an adaptive CNN that is continually updated.

In another embodiment, a depth is calculated for each sub-window by taking the average depth estimation for each pixel in left sub-window 110, middle sub-window 112, and/or right sub-window 114. Average depth estimation may be determined from Equation 1, Equation 2, and/or Equation 3, which average all the depth estimation values within left sub-window 110, middle sub-window 112, and/or right sub-window 114.

$${ω}_{L ( i = 0 )} = \frac{{\sum }_{k = i * x}^{i * x + x} ( {\sum }_{m = i * y}^{i * y + y} ( {d}_{p ( m , k )} ) )}{x * y} \qquad ( Equation 1 )$$

$${ω}_{M ( i = 1 )} = \frac{{\sum }_{k = i * x}^{i * x + x} ( {\sum }_{m = i * y}^{i * y + y} ( {d}_{p ( m , k )} ) )}{x * y} \qquad ( Equation 2 )$$

$${ω}_{R ( i = 2 )} = \frac{{\sum }_{k = i * x}^{i * x + x} ( {\sum }_{m = i * y}^{i * y + y} ( {d}_{p ( m , k )} ) )}{x * y} \qquad ( Equation 3 )$$

Equation 1, Equation 2, and Equation 3 return ω_{L(i=0)}, the average depth of left sub-window 110; ω_{M(i=1)}, the average depth of middle sub-window 112; and ω_{R(i=2)}, the average depth of right sub-window 114, respectively, and wherein:
(m, k) are the coordinates of a pixel in an image;
d_{p(m,k)} is the depth estimation value for the pixel located at position (m, k);
x is a first (e.g., horizontal) dimension of the respective sub-window in pixels; and
y is a second (e.g., vertical) dimension of the respective sub-window in pixels.

Test 210 makes a collision detection to determine if, absent a change in motion, UAV 102 would collide with the obstacle. Test 210 makes a “yes or no” collision decision as to whether collision avoidance (see step 212) operation is, or is not, required. Based on the calculated depth estimation, and a predetermined threshold, UAV 102 detects the obstacle. The predetermined threshold is a safety distance between UAV 102 and the obstacles after which UAV 102 should alter its direction (in one or more axes). Additionally or alternatively, the threshold is dynamically determined, such as a function of the current speed and/or maneuvering ability of UAV 102.

Test 210 compares the average depth value of middle sub-window 112, obtained from Equation 2, with the predetermined threshold. If the depth value of middle sub-window 112 is greater than the predetermined threshold, test 210 is determined in the negative, such as when UAV 102 is not facing an obstacle, and continuing forward travel presents no risk of collision. However, if the depth value of middle sub-window 112 is less than the predetermined threshold, test 210 is determined in the affirmative, such as when UAV 102 is heading towards the obstacle and an avoidance maneuver is required.

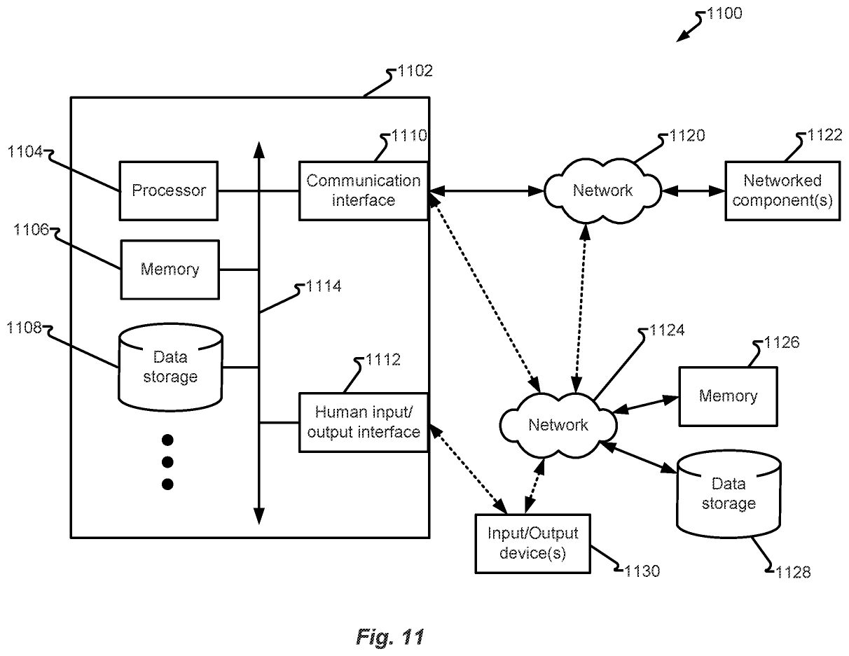

Additionally or alternatively, test 210 may determine that the average depth value of right sub-window 114, obtained from Equation 3, is lower than the predetermined threshold processing continues to step 212 to determine the change in flight path. Similarly, and as a further addition or alternative, test 210 may determine that the average depth value of left sub-window 110, obtained from Equation 1, is lower than the predetermined threshold and processing proceeds to step 212 to determine the change in flight path. If test 210 is determined in the negative, process 200 may end or, alternatively, loop back to step 202 to process a subsequent image. As a further option, UAV 102 may comprise a communication interface (e.g., communication interface 1110, FIG. 11) to a network (e.g., network 1120, FIG. 11), which may preferable be a wireless network, to a networked component (e.g., networked component(s) 1122, FIG. 11) located externally to UAV 102. The networked components comprising at least one processor and a corresponding network interface. UAV 102 transmits, via the network, images, sub-image, or other image portions to the networked component and receives therefrom the depth value for one or more pixels of the provided images.

Next, step 212 determines a change in flight path or other operation necessary to maneuver to avoid the obstacle. While a change in flight path may be executed in any axis of travel to avoid the obstacle, embodiments herein illustrate changes in the y-axis for clarity. Additionally or alternatively, step 212 may make a change in the current speed of UAV 102 to avoid the obstacle. For example, slowing UAV 102 may delay or negate any potential collision decision and the need for a directional and/or subsequent speed change.

In one embodiment, step 212 determines a direction for UAV 102 to avoid the detected obstacle. The direction determination is based, at least in part, on the depth estimations (see step 204) and a corresponding UAV control command 214 is provided to UAV 102. For example, if depth information of left sub-window 110 is greater than right sub-window 114, then obstacles to the left are further away from UAV 102 than obstacles to the right. Accordingly, step 212 instructs UAV 102 to turn to the right. As can be appreciated, the converse decision can be made to instruct UAV 102 to turn to the right as well as perform a different maneuver (e.g., climb, dive, slow, etc.). UAV 102 may continually save the last one or more depth estimation (step 204) values of left sub-window 110 and right sub-window 114. Equation 4 determines a decision parameter for right sub-window 114 using the depth estimation values (see Equation 3) and Equation 5 determines a decision parameter for left sub-window 110 using the depth estimation values (see Equation 1).

$$ρ R = {\sum }_{i = 0}^{n} ( {α}_{t - i} \times {ω}_{R ( t - i )} ) \qquad ( Equation 4 )$$

$$ρ L = {\sum }_{i = 0}^{n} ( {α}_{t - i} \times {ω}_{L ( t - i )} ) \qquad ( Equation 5 )$$

Equation 4 and Equation 5 return a decision parameter for right turn and left turn, respectively, wherein:
(t−i) is a time step. For example, for a current time frame, i=0; for the immediately preceding time frame, i=1; for the next preceding time frame, i=2, etc.;
ω_{L(i=0)} is the average depth of left sub-window 110 (see Equation 1);
ω_{R(i=2)} is the average depth of right sub-window 114 (see Equation 3); and
α is a weighting factor that gives more weight to more recent time frames.

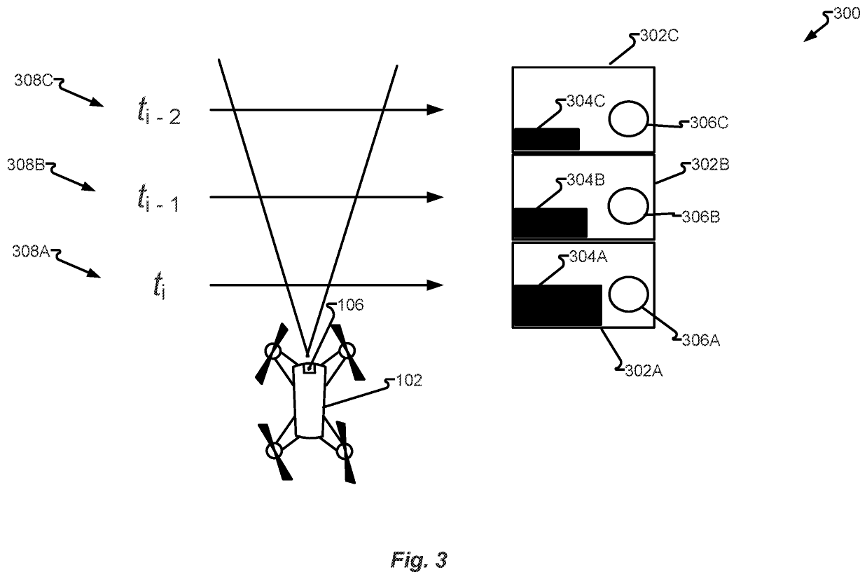

FIG. 3 depicts image processing 300 in accordance with embodiments of the present disclosure. UAV 102, utilizing camera 106, captures images, such as sub-image 302A at time step 308A, sub-image 302B at time step 308B, and sub-image 302C at time step 308C. Images captured may be unprocessed, that is, as captured by camera 106 and/or processed. Processed images may include depth maps. For example sub-image 302A, 302B, and 302C may be processed into a depth map wherein colors are applied to portions thereof to indicate distance or depth to the imaged obstacle. Accordingly, images of a foreground obstacle are captured as foreground obstacle image 304A, foreground obstacle image 304B, and foreground obstacle image 304C and are colored in a first color in accordance with a relatively close proximity to UAV 102. Images of a background obstacle are captured as background obstacle image 306A, background obstacle image 306B, and background obstacle image 306C and are colored in a second color in accordance with a greater distance to UAV 102. While the first and second colors are illustrated herein as black and white, colors may include a spectrum of grayscale or color images. For example, sub-images 302A-302C may be colored as a “heat map,” wherein portions of sub-images 302A-302C are colored red, for portions of an image having an obstacle in close proximity to UAV 102, and gradually transitioning to blue, for images of obstacles that are more distant.

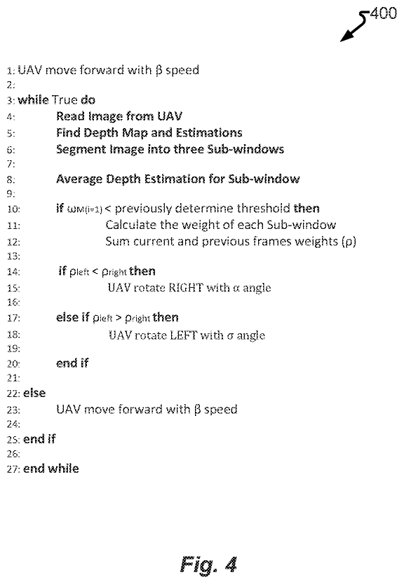

In one embodiment, an obstacle-free direction of travel is determined using a, and the weight given to each time step is as follows: αt=0.50 (308A), αt−1=0.30 (308B), and αt−2=0.20 (308C). This concept of time step can be extended to any number of time steps as long as the summation of α is exactly one. The foregoing values may be processed by algorithm 400 (see FIG. 4).

FIG. 4 depicts algorithm 400 in accordance with embodiments of the present disclosure. Algorithm 400 illustrates logical operations utilized to determine obstacle avoidance maneuvers. In one embodiment, algorithm 400 is embodied as machine-readable instructions maintained in a non-transitory memory that when read by a machine, such as processors of UAV 102, cause the machine to execute the instructions and thereby execute algorithm 400.

In one embodiment, algorithm 400 illustrates the operation logic of the overall system. Once algorithm 400 determines that there is an obstacle in front of UAV 102, algorithm 400 will calculate ρR and ρL. If ρR<ρL, then the average depth weight for the right side is less than the left side; hence UAV 102 is instructed to rotate left. Otherwise, if ρR>=ρL, UAV 102 is instructed to rotate right. After rotation, the process repeats to evaluate new frame data and make decisions accordingly.

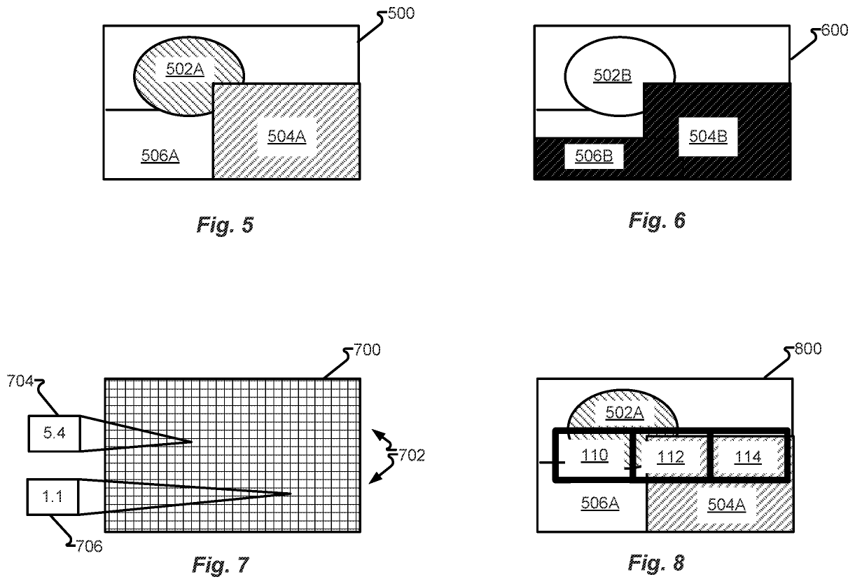

FIG. 5 depicts camera image 500 in accordance with embodiments of the present disclosure. Camera image 500 may be an image captured by camera 106 of UAV 102. It should be appreciated that camera image 500 is a photo-realistic image and is only being depicted herein as geometric shapes for the sake of clarity and reproducibility of this document. Camera image 500 captures raw images of background obstacle 502A, foreground obstacle 504A, and foreground obstacle (floor) 506A.

FIG. 6 depicts depth map 600 in accordance with embodiments of the present disclosure. Depth map 600 utilizes camera image 500 and applies color, or as illustrated black and while shading, in accordance with distances from camera 106 and UAV 102. Here, black indicates obstacles in close proximity (i.e., foreground obstacle 504B and foreground obstacle (floor) 506B), and white indicates obstacles at a greater distance (i.e., background obstacle 502B).

FIG. 7 depicts data structure 700 in accordance with embodiments of the present disclosure. Data structure 700 comprises an estimated depths for the pixels of camera image 500 and may be utilized to determine the colorization values utilized to generate depth map 600 (see FIG. 6). Data structure 700 comprises depth estimate 704 of background obstacle 502A and depth estimate 706 of foreground obstacle 504A, for each pixel of camera image 500 and/or depth map 600. It should be appreciated that depth values of depth map 702 may be provided for each pixel, although for the sake of clarity, only depth estimate 704 and depth estimate 706 are illustrated.

FIG. 8 depicts camera image 800 divided into portions comprising sub-windows 110, 112, and 114 in accordance with embodiments of the present disclosure. As an example, average depth estimation for all pixels present in left sub-window 110 is 2.9 meters, middle sub-window 112 is 1.7 meters, and right sub-window 114 is 2.1 meters. Next, the depth estimation for middle sub-window 112 is compared with the predetermined threshold for obstacle detection. If 1.7 meters is larger than the predetermined threshold, UAV 102 would be instructed to continue forward as no obstacle is present that poses a risk of a collision. Alternatively, if 1.7 meters is less than the predetermined threshold, UAV 102 would be instructed to rotate. In order to determine which direction UAV 102 should rotate, the depth estimations for the last three images are calculated as in equations 4 and 5. Here, the calculated values are: 3.4 meters for left sub-window 110, 3.4 meters for middle sub-window 112, and 2.6 meters for right sub-widow 114. Since the value for left sub-window 110 is greater than the value for right sub-window 114, obstacles are more distant on the left and, therefore, it is safer for UAV 102 to travel to the left. Accordingly, UAV 102 is instructed to rotate left.

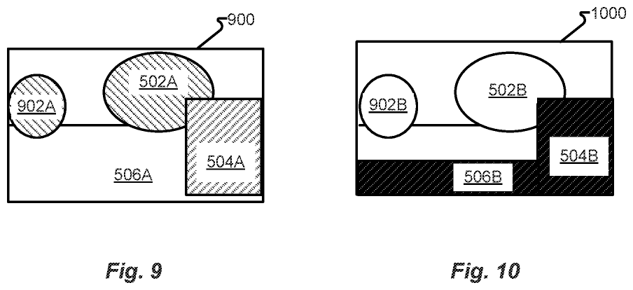

FIG. 9 depicts camera image 900 in accordance with embodiments of the present disclosure. Camera image 900 is captured by camera 106 of UAV 102 after rotation (see FIG. 8). Camera image 900 captures raw images of background obstacle 502A, foreground obstacle 504A, foreground obstacle (floor) 506A and, after rotation from capturing camera image 900, new background obstacle 902A.

FIG. 10 depicts depth map 1000 in accordance with embodiments of the present disclosure. Depth map 1000, utilizes camera image 900 (following a rotation command, see FIG. 8) and applies color, or as illustrated black and while shading, in accordance with distances from camera 106 and UAV 102. Here, black indicates obstacles in close proximity (i.e., foreground obstacle 504B and foreground obstacle (floor) 506B) and white indicates obstacles at a greater distance (i.e., background obstacle 502B), and new background obstacle 902B.

FIG. 11 depicts device 1102 in system 1100 in accordance with embodiments of the present disclosure. In one embodiment, UAV 102 may be embodied, in whole or in part, as device 1102 comprising various components and connections to other components and/or systems. The components are variously embodied and may comprise processor 1104. The term “processor,” as used herein, refers exclusively to electronic hardware components comprising electrical circuitry with connections (e.g., pin-outs) to convey encoded electrical signals to and from the electrical circuitry. Processor 1104 may comprise programmable logic functionality, such as determined, at least in part, from accessing machine-readable instructions maintained in a non-transitory data storage, which may be embodied as circuitry, on-chip read-only memory, computer memory 1106, data storage 1108, etc., that cause the processor 1104 to perform the steps of the instructions. Processor 1104 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 1114, executes instructions, and outputs data, again such as via bus 1114. In other embodiments, processor 1104 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 1104 is a non-transitory computing device (e.g., electronic machine comprising circuitry and connections to communicate with other components and devices). Processor 1104 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 1104). Processor 1104 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 1104, device 1102 may utilize computer memory 1106 and/or data storage 1108 for the storage of accessible data, such as instructions, values, etc. Communication interface 1110 facilitates communication with components, such as processor 1104 via bus 1114 with components not accessible via bus 1114 and may be embodied as a network interface (e.g., ethernet card, wireless networking components, USB port, etc.). Communication interface 1110 may be embodied as a network port, card, cable, or other configured hardware device. Additionally or alternatively, human input/output interface 1112 connects to one or more interface components to receive and/or present information (e.g., instructions, data, values, etc.) to and/or from a human and/or electronic device. Examples of input/output devices 1130 that may be connected to input/output interface include, but are not limited to, keyboard, mouse, trackball, printers, displays, sensor, switch, relay, speaker, microphone, still and/or video camera, etc. In another embodiment, communication interface 1110 may comprise, or be comprised by, human input/output interface 1112. Communication interface 1110 may be configured to communicate directly with a networked component or configured to utilize one or more networks, such as network 1120 and/or network 1124.

Network 1120 may be a wired network (e.g., Ethernet), such as to provide periodic communications, wireless (e.g., WiFi, Bluetooth, cellular, etc.) network, or combination thereof and enable device 1102 to communicate with networked component(s) 1122, which may include components operating a CNN. In other embodiments, network 1120 may be embodied, in whole or in part, as a telephony network (e.g., public switched telephone network (PSTN), private branch exchange (PBX), cellular telephony network, etc.).

Additionally or alternatively, one or more other networks may be utilized. For example, network 1124 may represent a second network, which may facilitate communication with components utilized by device 1102. For example, network 1124 may be an internal network to a business entity or other organization, whereby components are trusted (or at least more so) than networked components 1122, which may be connected to network 1120 comprising a public network (e.g., Internet) that may not be as trusted.

Components attached to network 1124 may include computer memory 1126, data storage 1128, input/output device(s) 1130, and/or other components that may be accessible to processor 1104. For example, computer memory 1126 and/or data storage 1128 may supplement or supplant computer memory 1106 and/or data storage 1108 entirely or for a particular task or purpose. As another example, computer memory 1126 and/or data storage 1128 may be an external data repository (e.g., server farm, array, “cloud,” etc.) and enable device 1102, and/or other devices, to access data thereon. Similarly, input/output device(s) 1130 may be accessed by processor 1104 via human input/output interface 1112 and/or via network interface 1110 either directly, via network 1124, via network 1120 alone (not shown), or via networks 1124 and 1120. Each of computer memory 1106, data storage 1108, computer memory 1126, and data storage 1128 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 1130 may be a router, a switch, a port, or other communication component such that a particular output of processor 1104 enables (or disables) input/output device 1130, which may be associated with network 1120 and/or network 1124, to allow (or disallow) communications between two or more nodes on network 1120 and/or network 1124. One of ordinary skill in the art will appreciate that other communication equipment may be utilized, in addition or as an alternative, to those described herein without departing from the scope of the embodiments.

In the foregoing description, for the purposes of illustration, methods (including algorithms) were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. An obstacle avoidance method for an unmanned vehicle, comprising:
receiving an image taken from a camera that is mounted on a position of the unmanned vehicle operated to fly within a flight path, wherein the camera has a field of view and a predetermined image size;
selecting a sub-image from the image for obstacle avoidance computation based on at least one of the field of view of the camera and the predetermined image size;
computing an average image depth value for all pixels in the selected sub-image;
comparing the average image depth value with a threshold value;
determining a presence of an obstacle based on the comparing; and
initiating an avoidance maneuver when the presence of the obstacle is determined based on the comparing so as to enable the unmanned vehicle to avoid the obstacle.

2. The method of claim 1, wherein the average image depth value for all pixels is computed using a trained model, and wherein the trained model comprises a probabilistic convolutional neural network.

3. The method of claim 1, wherein the selecting the sub-image from the image taken from the camera comprises dividing the image into a plurality of sub-images that includes the selected sub-image, and wherein at least two of the plurality of sub-images are non-overlapping.

4. The method of claim 2, further comprising: computing a depth map for each of a plurality of sub-images by computing an average depth for each of the plurality of sub-images.

5. The method of claim 3, wherein the computing, determining, and initiating are performed on the selected sub-image and the plurality of sub-images other than the selected sub-image is not used for the computing so as to reduce computing time.

6. The method of claim 3, wherein the selected sub-image comprises a size that is determined based on a size of the unmanned vehicle, a resolution of the camera and a field of view (FOV).

7. The method of claim 3, wherein the unmanned vehicle is moved in a direction away from the selected sub-image.

8. The method of claim 3, further comprising: capturing a first sub-image at a first time and a second sub-image at a second time for the selected sub-image, wherein the second time occurs after the first time.

9. The method of claim 8, further comprising:
computing a rotation parameter using the first sub-image and the second sub-image;
applying a first weight to the first sub-image; and
applying a second weight to the second sub-image, wherein the second weight is higher than the first weight.

10. The method of claim 9, further comprising: performing a rotation operation on the unmanned vehicle using the rotation parameter upon determining the presence of the obstacle.

11. A vehicle control system, comprising:
a processor configured to receive an image taken from a camera, wherein the camera has a field of view and a predetermined image size; and
memory comprising data stored thereon that, when executed by the processor, enables the processor to:
select a sub-image from the image for an obstacle avoidance computation based on at least one of the field of view of the camera and the predetermined image size;
compute an average image depth value for all pixels in the selected sub-image;
compare the average image depth value with a threshold value;
determine a presence of an obstacle based on the comparing; and
initiate an avoidance maneuver for a vehicle when the presence of the obstacle is determined based on the comparing so as to enable the vehicle to avoid the obstacle.

12. The vehicle control system of claim 11, wherein the average image depth value for all pixels is computed using a trained model, and wherein the trained model comprises a probabilistic convolutional neural network.

13. The vehicle control system of claim 11, wherein the image is divided into a plurality of sub-images, and wherein the sub-image is selected from the plurality of sub-images.

14. The vehicle control system of claim 11, wherein the image comprises at least one of an RGB image.

15. The vehicle control system of claim 11, wherein the vehicle comprises an unmanned vehicle.

16. The vehicle control system of claim 11, wherein the avoidance maneuver comprises adjusting a flight path of the vehicle.

17. A system, comprising:
a camera;
a first processor; and
first memory coupled with the first processor, wherein the first memory comprises data stored thereon that, when executed by the first processor, enables the first processor to:
select a sub-image from an image for an obstacle avoidance computation based on at least one of a field of view of the camera and a predetermined image size;
compute an average image depth value for all pixels in the selected sub-image;
compare the average image depth value with a threshold value;
determine a presence of an obstacle based on the comparing; and
initiate an avoidance maneuver for a vehicle when the presence of the obstacle is determined based on the comparing so as to enable the vehicle to avoid the obstacle.

18. The system of claim 17, wherein the data further enables the first processor to:
capture a first sub-image;
capture a second sub-image;
apply a first weight to the first sub-image;
apply a second weight to the second sub-image, wherein the second weight is different from the first weight; and
compute a rotation parameter based on applying the first weight to the first sub-image and based on applying the second weight to the second sub-image.

19. The system of claim 18, wherein the data further enables the first processor to:
instruct a vehicle to perform a rotation operation using the rotation parameter.

20. The system of claim 17, further comprising:
a communication interface to a network; and
a vehicle comprising the camera, first processor, first memory, and the communication interface; and
wherein the first processor computes the average image depth value for all pixels in the selected sub-image comprising providing the selected sub-image, via the network, to a second processor located externally to the vehicle and receiving therefrom the average image depth value for one or more of all pixels.
